(19) United States
(12) Patent Application Publication
(10) Pub. No.: US 2009/0107828 A1
(43) Pub. Date: Apr. 30, 2009

(54) KEYBOARD WITH FIVE-DIRECTION KEYS FOR PORTABLE ELECTRONIC APPARATUS

(76) Inventors: Wang-Hung Yeh, Taoyuan City (TW); Chung-Yu Liu, Taichung City (TW)

Correspondence Address: HDLS Patent & Trademark Services, P.O. BOX 220746, CHANTILLY, VA, 20153-0746, US

(21) Appl. No.: 11/926,293

(22) Filed: Oct. 29, 2007

(51) Int. Cl. H01H 21/00

(52) U.S. Cl. 200/6 A

(57) ABSTRACT

A keyboard with five-direction keys is used for a portable electronic apparatus. The keyboard includes a casing with a plurality of openings; and a plurality of keys arranged on the casing in array fashion. Four pattern areas are printed on four diagonal corners of each opening. A legend is printed on each of the pattern areas. The legend is one of letters A to Z, and special symbols such as star key and pound key, and direction signs. Each of the keys is located in one opening, and includes a joystick unit and a keycap arranged on the joystick unit. The keycap comprises a keytop thereon and the keytop is printed with one of numbers 0 to 9. The keyboard generates an electronic signal corresponding to one legend when the keycap is moved laterally in diagonal direction. The keyboard generates an electronic signal corresponding to a number when the keycap is pressed downward.

### BACKGROUND OF THE INVENTION

1. Field of the Invention

The present invention relates to a keyboard, especially to a keyboard for portable electronic apparatus.

2. Description of Prior Art

Keyboard is an indispensable input interface for user to operate an electronic apparatus. More particularly, keyboard provides entry of letters, numbers, symbols, and provides function input/execution for user when user is operating the electronic apparatus.

FIG. 1 shows the layout of a conventional QWERTY keyboard 10, which is popular as input interface for personal computer and laptop computer. The QWERTY keyboard is originally developed to reduce mechanical complexity of typewriter. Nowadays, it is widely accepted as standard layout for computer keyboard. A skillful typist can operate the keyboard without watching the keyboard after he or she memorizes the keyboard layout. The QWERTY keyboard 10 comprises a plurality of keys 101 arranged in array fashion. The keycap 102 of the key 101 is printed with legend to manifest the input content associated with the key 101. For example, the legend can be one of numbers, letters or symbols. In operating this kind of keyboard, user can use his/her ten fingers to press the desired keys by pressing the keycaps. An electronic signal corresponding to the key pressing operation is processed to display an on-screen typing result corresponding to the pressed keycap.

The portable electronic apparatus are made with more compact size and light weight as the progress of electronic technology. It is difficult to provide QWERTY keyboard on a compact portable electronic apparatus. The size of the keycap 102 for the QWERTY keyboard is forced to shrink when the QWERTY keyboard is arranged on a portable electronic apparatus. Therefore, user usually operates the down-sized QWERTY keyboard by single finger, which is inconvenient for user.

It is desirable to develop a keyboard with reduced key number while the keyboard can provide layout compatible to conventional keyboard such as QWERTY keyboard and provide non-ambiguous input function of letters, numbers and symbols.

### SUMMARY OF THE INVENTION

It is the object of the present invention to provide an input interface with reduced key number, which is advantageous for compact portable electronic apparatus. Accordingly, the present invention provides a keyboard for portable electronic apparatus. The keyboard comprises a casing and a plurality of keys arranged in array fashion. The casing comprises a plurality of openings defined thereon. Four pattern areas are printed on four diagonal corner of each opening. A second printed legend is printed on each of the pattern areas. The second printed legend is one of letters A to Z, and special symbols such as star key (asterisk key) *, and pound key (hash key) # symbols, and direction signs. Each of the keys is located in one opening and comprises a joystick unit and a keycap arranged on the joystick unit. The joystick unit comprises a circuit board and a stage electrically connected to the circuit board. A joystick body is engaged with the stage. The keycap comprises a keytop thereon and the keytop is printed with one of numbers 0 to 9.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows the layout of a conventional QWERTY keyboard.

FIG. 2 shows a top view of the keyboard with five-direction key according to the present invention.

FIG. 3 is a partially enlarged view of a single key.

FIG. 4 is a sectional view alone line 2-2 in FIG. 2.

FIG. 5 is a schematic view showing a pressing operation for the key.

FIG. 6 shows the top view illustrating the sliding movement of keycap of the present invention.

FIG. 7 shows the sectional view illustrating the sliding movement of keycap of the present invention.

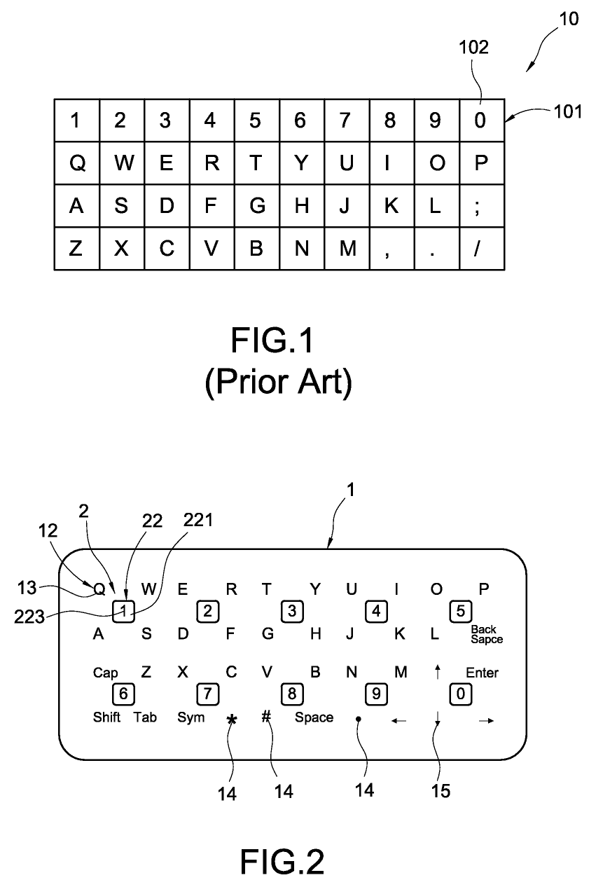

### DETAILED DESCRIPTION OF THE INVENTION

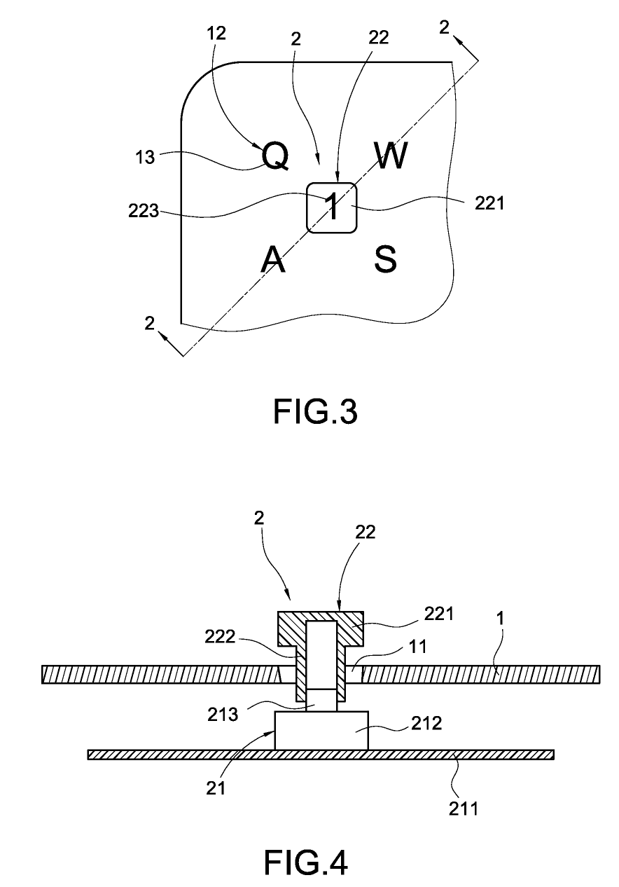

FIG. 2 shows a top view of the keyboard with five-direction key according to the present invention. FIG. 3 is a partially enlarged view of a single key. FIG. 4 is a sectional view alone line 2-2 in FIG. 2. With reference to FIGS. 2-4, the keyboard with five-direction key for portable electronic apparatus according to the present invention mainly comprises a keyboard casing 1 and a plurality of keys 2 arranged on the keyboard casing 1 in array fashion.

A plurality of openings 11 is defined on the keyboard casing 1 and each of the openings 11 has a tapered cross section with a wider top section. Four pattern areas 12 are provided for each of the openings 11. The pattern areas 12 are arranged on the keyboard casing 1 and located at four diagonal corners of the opening 11. The pattern areas 12 are printed with legends corresponding to English letters A to Z or the combination of letters A to Z, and special symbols such as star key (asterisk key) *, and pound key (hash key) # symbols, and direction signs. Each of the keys 2 comprises a joystick unit 21 and a keycap 22 arranged on the joystick unit 21. The joystick unit 21 comprises a circuit board 211 and a stage 212 electrically connected to the circuit board 211. The stage 212 comprises a joystick body 213; and the keycap 22 is of T-shaped cross section and comprises a keytop 211. The keytop 221 is engaged with a hollow post 222, which is capped on the joystick body 213. A numeric legend 223 is printed on the surface of the keytop 221, where the numeric legend 223 is corresponding to one of numbers 0 to 9. When the keycap 22 is moved to one of the diagonal corners, the stage 212 produces a corresponding input signal and the signal is sent by the circuit board 211.

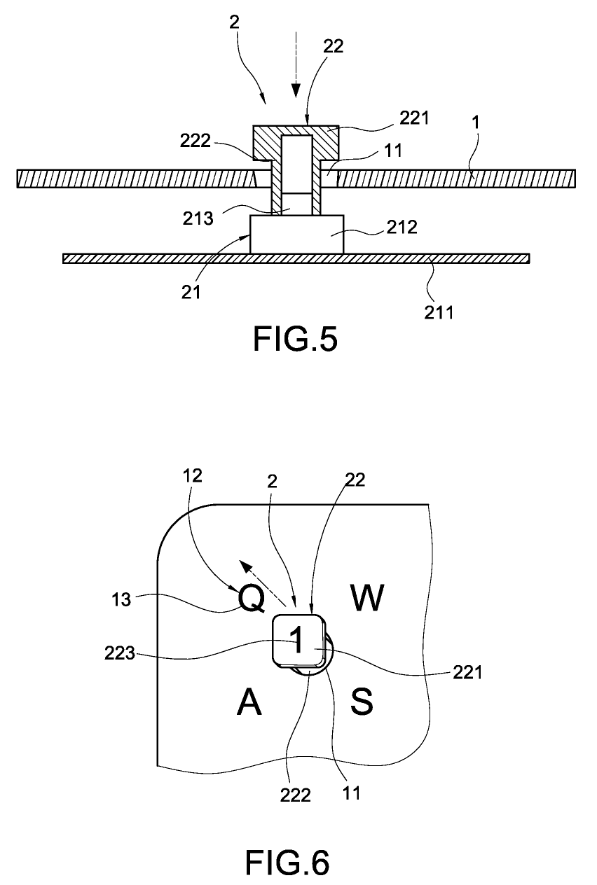

FIG. 5 is a schematic view showing a pressing operation for the key 2. As shown in this figure, the keytop 221 of the keycap 22 is pressed by user finger such that the hollow post 222 is lowered to press against the joystick body 213 of the joystick unit 21. A signal is generated by the stage 212 of the joystick unit 21 and corresponding to a numeric legend 223 on the keytop 221. The signal corresponding to the numeric legend 223 on the keytop 221 is sent to an electronic apparatus (not shown) through the circuit board 211. Therefore, an icon corresponding to the numeric legend 223 can be displayed on the electronic apparatus.

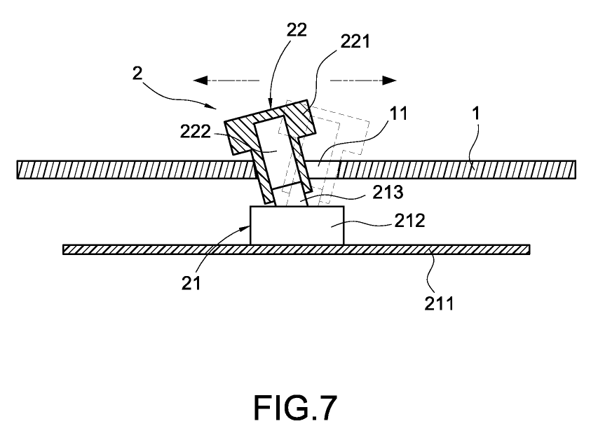

FIG. 6 and FIG. 7 show the top view and the sectional view illustrating the sliding movement of keycap 22 of the present invention, respectively. When the keycap 22 is slid from its original place by user to approach one of the pattern areas 12 at the diagonal corner, a signal is generated by the stage 212 of the joystick unit 21, wherein the signal is corresponding to a printed legend (which can be a letter 13 or a symbol 14 or a direction sign 15) manifested on the pattern areas 12. The signal corresponding to the printed legend on the pattern areas 12 is sent to an electronic apparatus (not shown) through the circuit board 211. Therefore, icon corresponding to the letter 13 and the symbol 14 can be displayed on the screen of the electronic apparatus. Alternatively, the cursor on the screen of the electronic apparatus can be moved according to the direction sign 15.

For example, when the keycap 22 is slid from its original place by user to the pattern area 12 with printed legend of letter “Q”, a signal corresponding to the letter “Q” is output by the circuit board 211. Therefore, an icon corresponding to the letter “Q” is displayed on the screen of the electronic apparatus.

Moreover, the numeric legend 223 can also be printed on the four diagonal corners of the opening 11 instead of on the keycap 22. The printed legends of letter 13 or symbol 14, or direction sign 15 can also be printed on the keycap 22 instead on the four diagonal corners of the opening 11.

Moreover, the printed legends of letters 13 printed on four diagonal corners of the opening 11 can be arranged in the order the same as English letters of QWERTY keyboard.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A five-direction key for a portable electronic apparatus, the five-direction key arranged on a keyboard casing for providing alphanumeric input and comprising:
a joystick unit comprising a circuit board and a stage, wherein the stage is electrically connected to the circuit board and is provided with a joystick body;
a keycap arranged on the joystick body and printed with a first printed legend thereon; and
four pattern areas arranged on four diagonal corners with respect to the keycap, wherein each of the pattern areas is printed with a second printed legend.

2. The five-direction key in claim 1, wherein the joystick body is able to move horizontally along diagonal direction with respect to the keycap.

3. The five-direction key in claim 1, wherein the joystick body is able to move vertically.

4. The five-direction key in claim 1, wherein the keycap is of T shape and comprises a keytop thereon, the keytop is engaged with a hollow post.

5. The five-direction key in claim 1, wherein the first printed legend is one of numbers 0 to 9.

6. The five-direction key in claim 1, wherein a plurality of openings are defined on the casing and each of the openings has a tapered cross section with a wider top section.

7. The five-direction key in claim 6, wherein the four pattern areas arranged on four diagonal corners of the opening.

8. The five-direction key in claim 1, wherein the second printed legend is one of letters A to Z, and special symbols comprising star key and pound key, and direction signs.

9. The five-direction key in claim 1, wherein the second printed legend is one of numbers 0 to 9.

10. The five-direction key in claim 1, wherein the first printed legend is one of letters A to Z, and special symbols comprising star key and pound key, and direction signs.

11. A keyboard with five-direction keys for a portable electronic apparatus, the keyboard providing alphanumeric input and comprising:
a keyboard casing comprising a plurality of openings defined thereon;
a plurality of keys arranged on the keyboard casing, each of the keys comprising a joystick unit and a keycap arranged on the joystick unit, wherein the keycap comprises a first printed legend thereon; and
four pattern areas arranged on four diagonal corners of each opening, wherein each of the pattern areas is printed with a second printed legend.

12. The keyboard in claim 11, wherein each of the openings has a tapered cross section with a wider top section.

13. The keyboard in claim 11, wherein the joystick unit comprises a circuit board and a stage electrically connected to the circuit board and comprising a joystick body.

14. The keyboard in claim 13, wherein the joystick body is able to move horizontally along diagonal direction of the opening.

15. The keyboard in claim 13, wherein the joystick body is able to move vertically

16. The keyboard in claim 13, wherein the keycap is of T shape and comprises a keytop thereon, wherein the keytop is engaged with a hollow post and the hollow post is capped to the joystick body, wherein the first printed legend is printed on the keytop.

17. The keyboard in claim 11, wherein the first printed legend is one of numbers 0 to 9.

18. The keyboard in claim 11, wherein the keys are arranged in 2×5 array.

19. The keyboard in claim 11, wherein one of the second printed legends is one of letters A to Z, and special symbols comprising star key and pound key, and direction signs.

20. The keyboard in claim 11, wherein the second printed legend is one of numbers 0 to 9.

21. The keyboard in claim 11, wherein the first printed legend is one of letters A to Z, and special symbols comprising star key and pound key, and direction signs.

22. The keyboard in claim 11, wherein the second printed legends are arranged in an order the same as English letters of QWERTY keyboard.
